(19) United States
(12) Patent Application Publication
(10) Pub. No.: US 2026/0157399 A1
(43) Pub. Date: Jun. 11, 2026

(54) SEAFOOD-BASED TREAT FOR COMPANION ANIMALS PRODUCED USING SEAFOOD AND METHOD FOR PRODUCING THE SAME

(71) Applicant: Ju Yeon JEON, Seoul (KR)

(72) Inventor: Ju Yeon JEON, Seoul (KR)

(21) Appl. No.: 19/326,830

(22) Filed: Sep. 12, 2025

(30) Foreign Application Priority Data
Dec. 10, 2024 (KR) 10-2024-0183086

(51) Int. Cl. A23K 10/22; A23K 10/30; A23K 30/20; A23K 50/42; B65B 7/02; B65B 25/00

(52) U.S. Cl. CPC A23K 10/22; A23K 10/30; A23K 30/20; A23K 50/42; B65B 7/02; B65B 25/001

(57) ABSTRACT

The present invention relates to a treat for companion animals produced using seafood, and a method for producing the same. Specifically, the present invention relates to a treat for improving the health and preference of companion animals by desalting and drying seafood, and a method for producing the same. The present invention provides a seafood-based treat and a method for producing the same to improve the preference and health of companion animals through the desalting and customized processing of seafood. The present invention provides a seafood-based treat for companion animals and a method for producing the same to enhance quality and preservability by applying a suitable treatment process according to the characteristics of the seafood.

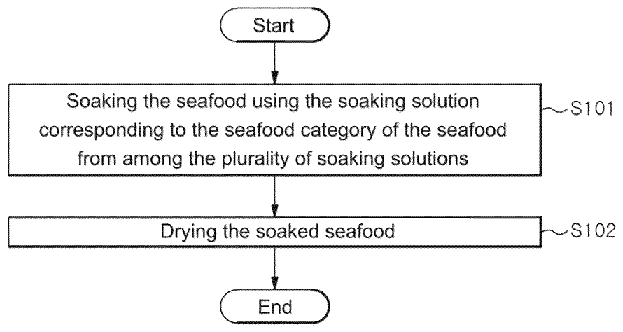

### CROSS-REFERENCE TO RELATED APPLICATION

This application claims priority to and the benefit of Korean Patent Application No. 10-2024-0183086, filed on Dec. 10, 2024, the disclosure of which is incorporated herein by reference in its entirety.

### BACKGROUND

### 1. Field of the Invention

The present invention relates to a seafood-based treat for companion animals and a method for producing the same. Specifically, the present invention relates to a treat for improving the health and preference of companion animals by desalting and drying seafood, and a method for producing the same.

### 2. Discussion of Related Art

The manufacturing technology of food products using seafood is a field that has long been developed as a source of nutrition for humans and animals. Seafood has high nutritional value as it contains various nutrients such as abundant protein, fatty acids, and minerals. In particular, as the market for companion animal treats expands, interest in seafood-based food for companion animals is increasing.

However, seafood has a problem in that it is difficult to maintain quality during the processing stage due to high salt content and the possibility of spoilage. In conventional technologies, various treatments have been attempted to improve desalting and preservability, but there have been limitations in efficiently removing salt while maintaining the nutrients and taste of the seafood.

Furthermore, the unique fishy odor and textural changes of seafood are factors that can lower the preference of companion animals. In particular, trimethylamine (TMA), known as a causative substance of the fishy odor, is difficult to remove, and thus an effective technology for reducing it is required. Failure to solve these problems may lead to a decrease in competitiveness in the companion animal treat market.

Conventional desalting technology has mainly been performed by soaking seafood in water for a certain period to elute salt. However, this method has low desalting efficiency and takes a long time, and there is also a possibility of damaging the tissue of the seafood. In addition, excessive desalting can lead to a loss of taste and nutrients.

Various technical difficulties also exist in the drying process. Conventional technologies such as hot-air drying, freeze-drying, and vacuum drying each have their advantages, but often fail to provide optimized drying conditions tailored to the characteristics of the seafood. If the drying conditions are not appropriate, destruction of nutrients and deformation of the tissue of the seafood may occur.

The lack of customized processing technology that considers the characteristics of seafood is also pointed out as a significant limitation. A method of categorizing seafood according to differences in fat content, protein content, and fishy odor components and selecting a suitable soaking solution composition accordingly has not been specifically proposed in conventional technologies. If such customized processing is not performed, the quality and effectiveness of the product may be limited.

In the companion animal treat market, storage stability and convenience are also important requirements. In conventional technologies, chemical preservatives were often used to ensure the preservability of treats, but this can cause consumer resistance. Therefore, antioxidant and antimicrobial technologies utilizing naturally derived ingredients are required.

To solve these limitations, the present invention proposes a customized soaking and drying technology based on the characteristics of seafood, and aims to improve the quality and preference of treats for companion animals. Furthermore, the present invention focuses on enhancing preservability through retort packaging and providing a high-quality treat that considers the health of companion animals.

### SUMMARY OF THE INVENTION

The present invention is directed to providing a seafood-based treat and a method for producing the same for improving the preference and health of companion animals through the desalting and customized processing of seafood.

The present invention is also directed to providing a seafood-based treat for companion animals and a method for producing the same for enhancing quality and preservability by applying a suitable treatment process according to the characteristics of the seafood.

The present invention is also directed to providing a seafood-based treat and a method for producing the same for producing a healthy treat for companion animals by simultaneously achieving salt reduction, fishy odor removal, and nutrient preservation. The present invention is also directed to providing a seafood-based treat and a method for producing the same for providing a safe and palatable treat to companion animals through customized soaking and drying of seafood.

The present invention is also directed to providing a seafood-based treat for companion animals and a method for producing the same for enhancing storage stability and preference while maintaining the quality of the seafood by utilizing naturally derived ingredients.

According to an aspect of the present invention, a method for producing a seafood-based treat for companion animals by desalting and drying seafood is provided. The method comprises: based on the seafood corresponding to one of a plurality of predetermined seafood categories, wherein each of the plurality of predetermined seafood categories corresponds to a respective one of a plurality of predetermined soaking solutions, soaking the seafood using the soaking solution corresponding to the seafood category of the seafood; and drying the soaked seafood. The plurality of seafood categories comprise: (a1) fish having a fat content greater than a threshold fat content; (b1) fish having a trimethylamine (TMA) content greater than a threshold TMA content, wherein the TMA is a component causing a fishy odor; (c1) fish having a protein content greater than a threshold protein content; and (d1) shellfish and crustaceans. The plurality of soaking solutions comprise: (a2) a composition of 2 wt % of rosemary extract, 1 wt % of grapefruit seed extract, 1 wt % of green tea extract, and 96 wt % of purified water; (b2) a composition of 1.5 wt % of green tea extract, 1 wt % of lemon extract, 1 wt % of *Ligularia fischeri(gomchwi) extract, 0.5 wt % of ginger extract, and 96 wt % of purified water; (c2) a composition of 1 wt % of licorice extract, 1 wt % of jujube extract, 0.5 wt % of cinnamon extract, 0.2 wt % of citric acid, and 97.3 wt % of purified water; and (d2) a composition of 1 wt % of green tea extract, 1 wt % of lemon balm extract, 1 wt % of licorice extract, and 97 wt % of purified water. The category (a1) corresponds to the soaking solution (a2), the category (b1) corresponds to the soaking solution (b2), the category (c1) corresponds to the soaking solution (c2), and the category (d1) corresponds to the soaking solution (d2).

According to an aspect of the present invention, a seafood-based treat for companion animals produced by the method according to embodiments of the present invention is provided.

### BRIEF DESCRIPTION OF THE DRAWINGS

The FIGURE illustrates a method for producing a seafood-based treat for companion animals by desalting and drying seafood, according to various embodiments of the present invention.

### DETAILED DESCRIPTION OF EXEMPLARY EMBODIMENTS

Hereinafter, embodiments of the present invention will be described in detail with reference to the accompanying drawings so that those of ordinary skill in the art to which the present invention pertains can easily carry it out. The present invention may be embodied in many different forms and is not limited to the embodiments set forth herein.

The FIGURE illustrates a method for producing a seafood-based treat for companion animals by desalting and drying seafood, according to various embodiments of the present invention.

Referring to the FIGURE, in step S101, the seafood is soaked using a soaking solution corresponding to the seafood category of the seafood, based on the seafood corresponding to one of a plurality of predetermined seafood categories, wherein each of the plurality of seafood categories corresponds to a respective one of a plurality of predetermined soaking solutions. According to various embodiments of the present invention, the embodiment of the FIGURE may include, before performing the soaking of the seafood according to step S101, a step of determining one seafood category to which the seafood corresponds from among the plurality of predetermined seafood categories.

According to various embodiments of the present invention, the embodiment of the FIGURE may further comprise, before performing the soaking of the seafood according to step S101, a step of removing skin, entrails, bones, and fatty parts from the seafood to form the seafood into a fillet. Accordingly, in step S101, the soaking of the seafood may be performed on the seafood in fillet form. The reason for soaking the seafood after forming it into a fillet is that processing it into a fillet increases the surface area of the seafood, thereby expanding the contact area with the soaking solution, which allows for more efficient desalting and component absorption. Furthermore, removing the skin, entrails, bones, and fatty parts eliminates unnecessary contaminants and fatty components that cause spoilage, which can prevent quality degradation during the soaking process. Through this, the taste, flavor, and texture of the final treat are improved, and a product that is safer and has a higher preference for companion animals to consume can be produced.

According to various embodiments of the present invention, the embodiment of the FIGURE may further comprise, before performing the soaking of the seafood according to step S101, a step of removing the shell of the seafood in a case where the seafood is a shellfish. In a case where the seafood is a shellfish, the reason for removing the shell before performing the soaking is that the shell can obstruct direct contact between the soaking solution and the internal tissue of the seafood, thereby inhibiting desalting and the absorption of active ingredients. Removing the shell allows the soaking solution to penetrate the surface and internal tissue of the seafood more evenly, which improves desalting efficiency and maximizes the effects of the soaking solution, such as antioxidant, antimicrobial, and tissue preservation effects. In addition, since the shell may contain contaminants or microorganisms that can cause deterioration during storage and distribution, removing it can further improve the sanitary condition and quality of the treat.

According to various embodiments of the present invention, the plurality of seafood categories may comprise: (a1) fish having a fat content greater than a threshold fat content; (b1) fish having a trimethylamine (TMA) content, which is a component causing a fishy odor, greater than a threshold TMA content; (c1) fish having a protein content greater than a threshold protein content; and (d1) shellfish and crustaceans.

According to various embodiments of the present invention, the threshold fat content may be 8 wt % to 12 wt % inclusive, based on a dry weight of the seafood. The reason for setting the threshold fat content to 8 wt % to 12 wt % inclusive is that if the fat content is less than 8%, it may not provide sufficient savory taste and nutritional value of the seafood, and if it exceeds 12%, spoilage may proceed rapidly, leading to degradation of the product's quality and preservability. This range is set as a balanced standard that can provide the necessary energy to companion animals through appropriate fat intake while inhibiting the deterioration of fat due to oxidation.

According to various embodiments of the present invention, the threshold TMA content may be 3 parts per million (ppm) to 7 ppm inclusive. The reason for setting the threshold TMA content to 3 ppm to 7 ppm inclusive is that TMA is the main causative substance of fishy odor, and if the content is less than 3 ppm, the inherent flavor of the seafood may be lacking, while if it exceeds 7 ppm, the fishy odor becomes strong, which may lower the preference of companion animals. This range is suitable for suppressing the fishy odor while maintaining the fresh flavor of the seafood and meets the preference and quality standards considering consumption by companion animals.

According to various embodiments of the present invention, the threshold protein content may be 15 wt % to 18 wt % inclusive, based on a dry weight of the seafood. The reason for setting the threshold protein content to 15 wt % to 18 wt % inclusive is that if the protein content is less than 15%, the main source of nutrients from the seafood becomes insufficient, and if it exceeds 18%, the texture of the tissue is more likely to degrade due to protein denaturation during the drying and storage process. This range is set as an ideal standard that can sufficiently supply the protein necessary for the health of companion animals while minimizing tissue changes and quality degradation.

According to various embodiments of the present invention, the plurality of soaking solutions may be: (a2) a composition of 2 wt % of rosemary extract, 1 wt % of grapefruit seed extract, 1 wt % of green tea extract, and 96 wt % of purified water; (b2) a composition of 1.5 wt % of green tea extract, 1 wt % of lemon extract, 1 wt % of Ligularia fischeri (gomchwi) extract, 0.5 wt % of ginger extract, and 96 wt % of purified water; (c2) a composition of 1 wt % of licorice extract, 1 wt % of jujube extract, 0.5 wt % of cinnamon extract, 0.2 wt % of citric acid, and 97.3 wt % of purified water; and (d2) a composition of 1 wt % of green tea extract, 1 wt % of lemon balm extract, 1 wt % of licorice extract, and 97 wt % of purified water.

Natural extracts such as rosemary extract, grapefruit seed extract, green tea extract, lemon extract, ginger extract, licorice extract, jujube extract, cinnamon extract, lemon balm extract, and citric acid can be obtained mainly by extraction from plant raw materials.

Rosemary extract can be obtained by mixing dried rosemary leaves with ethanol to extract antioxidant components (carnosol, rosmarinic acid, etc.). Rosemary extract has antioxidant and preservative effects.

Grapefruit seed extract can be obtained by drying and pulverizing grapefruit seeds and then extracting antimicrobial components (flavonoids, vitamin C, etc.) with ethanol. Grapefruit seed extract has antimicrobial and spoilage-inhibiting effects.

Green tea extract can be obtained by soaking green tea leaves in hot water to extract its main components (catechins, polyphenols, etc.). Green tea extract has antioxidant, fat spoilage-inhibiting, and fishy odor-reducing effects.

Lemon extract can be obtained by extracting lemon oil by steam-distilling the peel. Lemon extract has the effects of removing fishy odor and providing a sour taste.

Ligularia fischeri (gomchwi) extract can be obtained by processing the leaves or stems of Ligularia fischeri with hot water to extract antimicrobial components. Ligularia fischeri extract has flavor-improving and antimicrobial effects.

Ginger extract can be obtained by finely chopping ginger and extracting components such as gingerol and shogaol with ethanol. Ginger extract has fishy odor-removing and antimicrobial effects.

Licorice extract can be obtained by boiling licorice in water to extract glycyrrhizin and flavonoids. Licorice extract has antioxidant and tissue-stabilizing effects.

Jujube extract can be obtained by boiling jujubes to extract antioxidant components (polyphenols, flavonoids, etc.). Jujube extract has tissue-preserving and taste-improving effects.

Cinnamon extract can be obtained by extracting a concentrate of antimicrobial and antioxidant components from cinnamon bark with ethanol. Cinnamon extract has antimicrobial and anti-spoilage effects.

Lemon balm extract can be obtained by soaking lemon balm leaves in hot water to extract antimicrobial and antioxidant substances (rosmarinic acid, etc.). Lemon balm extract has antimicrobial and tissue-strengthening effects.

Citric acid can be obtained by fermenting sugars with a mold (Aspergillus niger). Citric acid has the effects of pH adjustment and inhibition of protein denaturation.

Natural extracts such as rosemary extract, grapefruit seed extract, green tea extract, lemon extract, ginger extract, licorice extract, jujube extract, cinnamon extract, lemon balm extract, and citric acid are available for purchase as commercialized food-grade raw materials and can be procured from specialized extract manufacturers without being produced directly. Safe extracts can be secured as commercialized raw materials through reliable manufacturers with HACCP and ISO certifications.

Natural extracts such as rosemary extract, grapefruit seed extract, green tea extract, lemon extract, ginger extract, licorice extract, jujube extract, cinnamon extract, lemon balm extract, and citric acid are primarily obtained by extracting active ingredients from raw materials through methods such as hot water extraction, ethanol extraction, and steam distillation, and these can be extracted in-house or purchased as commercial extracts from reliable manufacturers with HACCP and ISO certifications.

According to various embodiments of the present invention, the category a1 may correspond to the soaking solution a2, the category b1 may correspond to the soaking solution b2, the category c1 may correspond to the soaking solution c2, and the category d1 may correspond to the soaking solution d2.

According to various embodiments of the present invention, the category a1 may include fish in which spoilage may proceed rapidly due to a fat content greater than the threshold fat content, and may include mackerel, salmon, herring, yellowtail, Spanish mackerel, tuna, yellow croaker, and Atka mackerel.

The category b1 may include fish which may have low consumer preference due to a fishy odor caused by a TMA content greater than the threshold TMA content, and may include saury, sardine, horse mackerel, anchovy, hairtail, jack mackerel, sambari (a type of grouper), and skate.

The category c1 may include fish in which textural changes may occur due to protein denaturation from a protein content greater than the threshold protein content, and may include cod, pollock, flounder, sea bream, rockfish, tilefish, capelin, freshwater eel, and icefish.

The category d1 may include seafood with delicate tissue that may be susceptible to quality degradation during preservation, and may include squid, shrimp, crab, abalone, scallop, pen shell, and blue crab.

According to various embodiments of the present invention, in the soaking solution a2, the rosemary extract, the grapefruit seed extract, and the green tea extract may inhibit oxidation of fat in the seafood based on their antioxidant components. The soaking solution for fish with a high fat content includes rosemary extract (2 wt %), grapefruit seed extract (1 wt %), and green tea extract (1 wt %), which are rich in antioxidant components, to inhibit fat spoilage. Rosemary extract delays fat oxidation through its powerful antioxidant effect, while grapefruit seed extract and green tea extract prevent the spoilage of fat and maintain the freshness of the seafood. The use of 96 wt % of purified water is optimized to allow for the even penetration of active ingredients, and this composition maximizes the quality and preservability of fish with high fat content.

According to various embodiments of the present invention, in the soaking solution b2, the green tea extract and the lemon extract may reduce the fishy odor of the seafood, and the

Ligularia fischeri (gomchwi) extract and the ginger extract may improve the flavor of the seafood. The soaking solution for fish with a high TMA content includes green tea extract (1.5 wt %), lemon extract (1 wt %),

Ligularia fischeri (gomchwi) extract (1 wt %), and ginger extract (0.5 wt %) to effectively remove fishy odor and improve flavor. Green tea extract and lemon extract suppress TMA and reduce fishy odor, and

Ligularia fischeri extract improves the flavor with its unique fresh scent. Ginger extract provides an antimicrobial effect while complementing the flavor to enhance the preference of companion animals. The 96 wt % of purified water maintains the uniformity of the soaking solution to maximize the fishy odor reduction effect.

According to various embodiments of the present invention, in the soaking solution c2, the licorice extract and the jujube extract may provide an antioxidant effect, the cinnamon extract may provide an antimicrobial effect, and the citric acid may preserve the texture of the tissue by inhibiting protein denaturation in the seafood through pH adjustment. The soaking solution for fish with a high protein content includes licorice extract (1 wt %), jujube extract (1 wt %), cinnamon extract (0.5 wt %), and citric acid (0.2 wt %) to prevent protein denaturation and preserve texture. Licorice extract and jujube extract provide an antioxidant effect to inhibit protein denaturation, and cinnamon extract prevents microbial growth through its antimicrobial action. Citric acid adjusts the pH to minimize protein denaturation and preserve the texture of the tissue. The 97.3 wt % of purified water helps the active ingredients to be evenly distributed, contributing to quality maintenance.

According to various embodiments of the present invention, in the soaking solution d2, catechins in the green tea extract may improve the preservability of the seafood by inhibiting microbial growth, and the lemon balm extract and the licorice extract may improve the elasticity of the tissue of the seafood through antimicrobial and antioxidant actions. The soaking solution for shellfish and crustaceans with delicate tissue includes green tea extract (1 wt %), lemon balm extract (1 wt %), and licorice extract (1 wt %) to provide antimicrobial and antioxidant effects to maintain the elasticity of the tissue. The catechin components in the green tea extract inhibit microbial growth along with providing an antioxidant effect, the lemon balm extract enhances the elasticity of the tissue, and the licorice extract provides antimicrobial and anti-inflammatory effects to increase preservability. The 97 wt % of purified water allows the soaking solution components to act uniformly, thereby improving the texture of the tissue.

According to various embodiments of the present invention, the soaking of the seafood may be performed using the soaking solution in an amount of at least five times the weight of the seafood. The reason for using a soaking solution in an amount of at least five times the weight of the seafood during the soaking process is to ensure even desalting and soaking effects across the surface and interior of the seafood through a sufficient amount of soaking solution. If the amount of the soaking solution is less than five times the weight of the seafood, the ion concentration difference between the seafood and the soaking solution may decrease rapidly, which can reduce the efficiency of desalting and component absorption. On the other hand, using a soaking solution of at least five times the weight allows the seafood to be completely submerged in the soaking solution, ensuring a uniform treatment effect, and the penetration of the soaking solution components and desalting are achieved more effectively. This set value is an optimal standard that can minimize resource waste while maintaining a balance between desalting and quality improvement.

According to various embodiments of the present invention, the soaking may be performed until a rate of change per hour in a salt concentration of the soaking solution is within a predetermined range. The predetermined range may correspond to a case where the change in salt concentration is 0.5% or less for 30 minutes. The predetermined range may correspond to a case where the change in salt concentration is 1% or less for 1 hour. The reason why measuring the rate of change per hour of the salt concentration in the soaking solution is more practical than measuring the rate of change per hour of the salt concentration within the seafood is that the soaking solution is a uniformly mixed liquid, allowing for real-time concentration monitoring by directly inserting a sensor. In contrast, the salt concentration inside the seafood is not uniform due to its complex solid structure, and accurate measurement requires additional sampling, leaching processes, or chemical analysis. Measuring the salt concentration in the soaking solution allows for indirect monitoring of the salt transfer between the seafood and the soaking solution, making process control simple and efficient, and facilitating automation even in large-scale industrial processes.

In step S102, the seafood for which the soaking in step S101 has been completed is dried.

According to various embodiments of the present invention, the drying of the seafood may include at least one of vacuum drying, hot-air drying, and freeze-drying.

According to various embodiments of the present invention, the vacuum drying may be performed by drying the seafood at a temperature of 50° C. or less and a vacuum pressure of −0.8 bar or more for 2 to 6 hours. The reason for setting the temperature to 50° C. or less in vacuum drying is to protect the heat-sensitive tissue and nutrients of the seafood. In a vacuum, the evaporation temperature of water is lowered, allowing for effective moisture removal without high heat. Setting the vacuum pressure to −0.8 bar or more further promotes water evaporation and inhibits oxidation reactions, thereby preventing quality degradation. The drying time is set to 2 to 6 hours to ensure sufficient moisture removal while preventing tissue damage from excessive time.

According to various embodiments of the present invention, the hot-air drying may be performed by drying the seafood using hot air at a temperature of 60° C. to 80° C. for 3 to 8 hours. The reason for setting the temperature between 60° C. and 80° C. in hot-air drying is that this range is optimal for balanced removal of moisture from the surface and interior of the seafood. Below 60° C., the drying time may become excessively long, reducing production efficiency, and above 80° C., there is a high risk of protein denaturation and tissue damage. The drying time is set to 3 to 8 hours to provide flexibility according to the size and thickness of the seafood while maintaining a high-quality dried state.

According to various embodiments of the present invention, the freeze-drying may be performed by freezing the seafood at −40° C. or less and then drying at a vacuum pressure of 0.1 mbar or less for 12 to 24 hours. The reason for setting the temperature to −40° C. or less in freeze-drying is to stably freeze the moisture in the seafood into a solid state to facilitate the sublimation process. If the temperature is above −40° C., ice crystal formation may be incomplete, which can cause quality degradation during the drying process. Setting the vacuum pressure to 0.1 mbar or less is to maximize the sublimation of water, thereby improving the drying speed and effectively inhibiting oxidation and microbial growth. The drying time is set to 12 to 24 hours to ensure long-term preservability by completely removing moisture from the interior of the seafood and to maintain high-quality texture and nutrients.

According to various embodiments of the present invention, the embodiment of the FIGURE may, after step S102, further comprise a step of sealing the seafood for which the drying in step S102 has been completed in a retort pouch comprised of a heat-resistant film. Alternatively, after step S102, the embodiment may further comprise a step of slicing the seafood for which the drying in step S102 has been completed into a predetermined size for easy consumption by companion animals, and then sealing it in a retort pouch comprised of a heat-resistant film. The reason for sealing the dried seafood in a retort pouch made of a heat-resistant film is to protect the dried seafood from external air, moisture, and microorganisms to ensure long-term preservability. Retort packaging can maintain the freshness and sanitary condition of the seafood without deformation of the packaging material even during heat treatment, and it prevents product quality degradation through its antimicrobial and sealing properties. Furthermore, it minimizes environmental impacts that may occur during the distribution and storage of the companion animal treat, thereby providing a safe and hygienic product to consumers.

The present invention has the technical feature of categorizing seafood into fish with high fat content, fish with high TMA content, fish with high protein content, and shellfish and crustaceans with delicate tissue, based on key characteristics such as the fat content, TMA content, and protein content of the seafood, and using a soaking solution optimized for each category. This customized soaking goes beyond simply desalting and can achieve additional effects such as antioxidant, antimicrobial, fishy odor removal, and tissue preservation, depending on the characteristics of each seafood. For example, for fish with high fat content, a soaking solution fortified with antioxidant components is used to inhibit spoilage, and for fish with high TMA content, a soaking solution containing components with excellent fishy odor removal effects is applied. In the case of fish with high protein content, a soaking solution that can prevent protein denaturation and preserve texture is used, and for shellfish and crustaceans with delicate tissue, a soaking solution that improves antimicrobial properties and tissue elasticity is utilized. This category-based soaking technology is a key differentiating factor that maximizes the quality and preference of the seafood, providing superior results compared to existing known technologies.

According to various embodiments of the present invention, there is provided a seafood-based treat for companion animals, which is produced by the production method according to the embodiments of the FIGURE. The seafood-based treat for companion animals produced according to the embodiments of the present invention has the technical effect of providing a high-quality treat that supports the health of companion animals, as it is produced through a customized soaking and drying process according to the characteristics of the seafood, with salt effectively removed. In such a treat, fat spoilage and protein denaturation are minimized, so nutrients are preserved, and the fishy odor is reduced, thereby increasing the preference of companion animals.

The seafood-based treat for companion animals produced according to the present invention has a superior technical effect in quality and preference compared to treats produced by conventional methods because it undergoes a soaking process optimized according to the characteristics of the seafood. For fish with high fat content, fat spoilage is inhibited through a soaking solution fortified with antioxidant components, providing a fresher taste and nutrition, and for fish with high TMA content, the fishy odor is effectively removed, greatly improving the consumption preference of companion animals. For fish with high protein content, the texture is maintained by minimizing protein denaturation, and for shellfish and crustaceans with delicate tissue, the quality is maintained even after long-term storage through antimicrobial and elasticity-improving effects. As such, the treat produced through this category-optimized soaking process is safer and healthier for companion animals and provides a fresh texture, thereby achieving an overall superior technical effect compared to treats produced by conventional methods.

The seafood-based treat for companion animals produced by the production method of the present invention, unlike existing known technologies, provides superior quality and preference compared to conventional treats by categorizing seafood according to characteristics such as fat content, TMA content, and protein content, and processing it using a soaking solution optimized for each category. In particular, through this customized soaking process, effects such as inhibition of protein denaturation, reduction of fishy odor, inhibition of fat spoilage, and maintenance of texture can be achieved.

Experiments were conducted to evaluate the effects of the present invention through an Example and a Comparative Example, focusing on the inhibition of protein denaturation, reduction of fishy odor, inhibition of fat spoilage, and maintenance of texture.

### Example

To produce a seafood-based treat for companion animals according to the present invention, the following procedure was applied:
(1) Seafood Preparation: Four types of seafood were used: mackerel, horse mackerel, tilefish, and abalone (corresponding to a1, b1, c1, and d1, respectively).
(2) Soaking Solution:
a1: Applied to mackerel: 2 wt % of rosemary extract, 1 wt % of grapefruit seed extract, 1 wt % of green tea extract, and 96 wt % of purified water (focused on antioxidant effects).
b1: Applied to horse mackerel: 1.5 wt % of green tea extract, 1 wt % of lemon extract, 1 wt % of Ligularia fischeri (gomchwi) extract, 0.5 wt % of ginger extract, and 96 wt % of purified water (focused on fishy odor removal).
c1: Applied to tilefish: 1 wt % of licorice extract, 1 wt % of jujube extract, 0.5 wt % of cinnamon extract, 0.2 wt % of citric acid, and 97.3 wt % of purified water (focused on protein preservation).
d1: Applied to abalone: 1 wt % of green tea extract, 1 wt % of lemon balm extract, 1 wt % of licorice extract, and 97 wt % of purified water (focused on tissue preservation).
(3) Treat Production:

The seafood was prepared in fillet form (for abalone, the shell was removed).

The seafood was soaked in a soaking solution in an amount of at least five times the weight of the seafood until the rate of change per hour of the salt concentration in the soaking solution stabilized at 1% or less.

After soaking, all seafood was hot-air dried under a single condition (60° C. for 6 hours).

### Comparative Example

A seafood treat was produced according to generally known technology:
(1) Seafood Preparation: Mackerel, horse mackerel, tilefish, and abalone (same conditions).
(2) Soaking Solution: Plain purified water was used for the sole purpose of desalting.
(3) Treat Production:

All seafood was prepared in fillet form (for abalone, the shell was removed).

The seafood was soaked for 12 hours in a soaking solution in an amount of two times the weight of the seafood.

It was hot-air dried under a single condition (60° C. for 6 hours).

### Experimental Evaluation Items, Methods, Conditions, and Results

### (1) Evaluation Items

For a1, Inhibition of fat spoilage: Peroxide Value (meq/kg) was measured.

For b1, Reduction of fishy odor: TMA concentration (ppm) was measured.

For c1, Inhibition of protein denaturation: Hardness of the tissue was measured (using a texture analyzer).

For d1, Maintenance of texture: Elasticity of the tissue was measured (using a texture analyzer).

For all categories, Preference: The preference of companion animals was tested (animal experiment).

### (2) Preference Evaluation Method

The preference evaluation was conducted to quantitatively compare whether the treat from the Example according to the present invention was preferred by companion animals over the treat from the Comparative Example.

Test Animals: 20 companion dogs (a mix of small, medium, and large breeds).

Age Distribution of Test Animals: 1 to 8 years old.

Health Status of Test Animals: Only individuals with normal body weight and digestive function were selected through a pre-experiment health check.

Test Location: A dedicated breeding facility (an environment with minimized noise and stress).

Feeding Time: 1:00 PM.

Condition Control: The same feed and water were provided throughout the experimental period, except for the treats.

Experimental Method: Treat samples from the Example and the Comparative Example were prepared in the same size and shape, and samples of the same weight (10 g) were provided. The two samples were placed at an equal distance (30 cm) in front of each dog. The percentage of dogs that chose to eat the treat from the Example first over the treat from the Comparative Example was calculated.

### (3) Experimental Conditions

Measurement Timing for Each Evaluation Item: Day 0 and Day 7 after soaking and drying.

The specific evaluation items and measurement methods are shown in [Table 1] below.

TABLE 1

| Seafood | | Unit of | |
|---|---|---|---|
| Category | Evaluation Item | Measurement | Measurement Method |
| a1 | Peroxide Value | meq/kg | Peroxide value measured by titration |
| b1 | TMA | ppm | TMA analyzed by gas chromatography |
| | Concentration | | |
| c1 | Tissue Hardness | N (Newton) | Hardness measured by a texture |
| | | | analyzer |
| d1 | Tissue Elasticity | % (Recovery | Recovery rate after deformation |
| | | Rate) | measured by a texture analyzer |
| All | Preference | % | Percentage of companion animals that |
| categories | | | chose the sample |

The specific measurement methods for each evaluation item are as follows.

### a1 Mackerel: Inhibition of Fat Spoilage

### Evaluation Item: Peroxide Value (PV)

Definition: The degree of spoilage is evaluated by measuring the concentration of peroxides produced in the initial stage of fat oxidation.

Measurement Method: A 5 g sample was extracted with an organic solvent, specifically, a mixed solvent of glacial acetic acid and chloroform. A saturated potassium iodide (KI) solution was added to the sample to react with the peroxides. The resulting iodine was titrated with a sodium thiosulfate (Na₂S₂O₃) solution. The peroxide value (PV, unit: meq/kg) was calculated based on the volume of sodium thiosulfate used for titration. The formula is PV=(V*N*1000)/(sample weight), where V is the volume of sodium thiosulfate used (unit: ml) and N is the normality of the sodium thiosulfate.

Interpretation of Measurement Results: A low peroxide value indicates that fat spoilage has been inhibited, while a high value signifies that spoilage has progressed.

### b1 Horse Mackerel: Reduction of Fishy Odor

### Evaluation Item: TMA (Trimethylamine) Concentration

Definition: The concentration of TMA (trimethylamine), the main substance causing fishy odor, is measured.

Measurement Method: A sample of the seafood, specifically 5 g, was prepared and then subjected to a distillation process to extract the liberated TMA. A 0.1N HCl solution was used as the distillation solvent. The distillation time was 10 minutes. The conditions for gas chromatography were as follows: a non-polar column (DB-5) was used, the mobile phase was helium (He) gas, the injection temperature was 200° C., and a Mass Spectrometry (MS) detector was used. The extracted TMA sample was injected into the gas chromatograph, separated inside the column, and then analyzed by the detector. The concentration (ppm) was measured based on the peak area of TMA.

Interpretation of Measurement Results: A low TMA concentration indicates that the fishy odor has been effectively removed, while a high TMA concentration means the fishy odor is still present.

### c1 Tilefish: Inhibition of Protein Denaturation

### Evaluation Item: Tissue Hardness

Definition: The degree of tissue softening due to protein denaturation is quantitatively measured.

Measurement Method: Samples cut to a uniform size and thickness were prepared. Specifically, they were cut into 1 cm³ cubes. A conical probe was attached to a Texture Analyzer. The probe speed was set to 1 mm/s. The sample deformation was set to 50% of the sample thickness. The probe was pressed vertically onto the sample to compress it, and the force generated at this time was recorded in Newtons (N).

Interpretation of Measurement Results: A high hardness value indicates that protein denaturation is minimal and the tissue is stable, while a low hardness value signifies that denaturation has progressed.

### d1 Abalone: Maintenance of Texture

### Evaluation Item: Tissue Elasticity

Definition: The ability of the tissue to return to its original state after deformation is measured to evaluate the degree of texture maintenance.

Measurement Method: The abalone was cut into uniform sizes, specifically, 1 cm in diameter and 0.5 cm in thickness. A cylindrical probe was attached to the Texture Analyzer. The compression speed was 1 mm/s, and the deformation was set to 30% of the sample thickness. The tissue was compressed to a certain strain rate with the texture analyzer, and then the recovery rate (%) was calculated. Specifically, after compressing the sample with the probe, the probe was removed, and the recovery rate of the tissue was calculated. The formula is (Recovery Rate)=(Recovered Thickness)/(Pre-compression Thickness)*100.

Interpretation of Measurement Results: A high recovery rate means the tissue structure is stable and denaturation has been inhibited, while a low recovery rate indicates that tissue damage has progressed.

### a1, b1, c1, d1 All Seafood: Preference

### Evaluation Item: Preference Rate

Definition: The preference is evaluated by measuring the rate at which companion animals choose a specific sample.

Measurement Method: Under identical conditions (10 g each, placed at the same distance of 30 cm), the percentage (%) of companion animals that chose the Example versus the Comparative Example was measured.

Interpretation: A high selection rate means that the corresponding treat has a higher preference for companion animals.

### (4) Experimental Results

The experimental results were as shown in [Table 2] below.

TABLE 2

| | | | Day 0 | Day 7 | Day 0 After | Day 7 After |
|---|---|---|---|---|---|---|
| | | | After | After | Soaking | Soaking |
| | Evaluation | | Soaking | Soaking | Comparative | Comparative |
| Seafood | Item | Unit | Example | Example | Example | Example |
| Mackerel | Peroxide | meq/kg | 2.5 | 3.5 | 8.1 | 12.3 |
| | Value | | | | | |
| Horse | TMA | ppm | 3.2 | 4.4 | 5.6 | 8.7 |
| Mackerel | Concentration | | | | | |
| Tilefish | Tissue | N | 63 | 52 | 51 | 44 |
| | Hardness | | | | | |
| Abalone | Tissue | % | 85 | 80 | 75 | 67 |
| | Elasticity | | | | | |
| All | Preference | % | 55 | 65 | 45 | 35 |
| Seafood | | | | | | |

The interpretation of the results from [Table 2] is as follows.

### a1 Mackerel: Inhibition of Fat Spoilage

Immediately after Soaking (Day 0 after Soaking):

Example: At 2.5 meq/kg, there was little fat spoilage.

Comparative Example: At 8.1 meq/kg, spoilage had already progressed from the initial stage.

7 Days after Soaking:

Example: At 3.5 meq/kg, spoilage had slightly progressed but remained stable compared to the Comparative Example.

Comparative Example: At 12.3 meq/kg, spoilage had progressed rapidly.

Conclusion: The Example was effective in inhibiting fat spoilage and maintaining quality.

### b1 Horse Mackerel: Reduction of Fishy Odor

Immediately after Soaking (Day 0 after Soaking):

Example: With a TMA concentration of 3.2 ppm, the fishy odor was effectively removed.

Comparative Example: With a TMA concentration of 5.6 ppm, the fishy odor still remained.

7 Days after Soaking:

Example: The concentration slightly increased to 4.4 ppm but remained at a low level.

Comparative Example: The concentration significantly increased to 8.7 ppm, and the fishy odor intensified.

Conclusion: The Example was much more effective in suppressing the substance causing fishy odor (TMA).

### c1 Tilefish: Inhibition of Protein Denaturation

Immediately after Soaking (Day 0):

Example: With a tissue hardness of 63 N, the tissue was stable as protein denaturation was inhibited.

Comparative Example: At 51 N, which was lower than the Example, protein denaturation had progressed further.

7 Days after Soaking:

Example: The hardness slightly decreased to 52 N but remained stable.

Comparative Example: The hardness significantly decreased to 44 N, indicating that protein denaturation had intensified and tissue damage was apparent.

Conclusion: The Example was effective in inhibiting protein denaturation and maintaining the stability of the tissue.

### d1 Abalone: Maintenance of Texture

Immediately after Soaking (Day 0 after Soaking):

Example: With a high elasticity of 85%, the tissue was firmly maintained.

Comparative Example: With a somewhat lower elasticity of 75%, there was a possibility of tissue damage.

7 Days after Soaking:

Example: The elasticity slightly decreased to 80% but was stably maintained.

Comparative Example: The elasticity significantly decreased to 67%, and tissue damage was apparent.

Conclusion: The Example effectively preserved the quality of the abalone tissue by maintaining its elasticity.

### a1, b1, C1, d1 all Seafood: Preference

Immediately after Soaking (Day 0 after Soaking):

Example: With a high preference rate of 55%, it was more preferred by companion animals.

Comparative Example: With a lower preference rate of 45%, it was less preferred than the Example.

7 Days after Soaking:

Example: The rate slightly increased to 65%, maintaining a stable preference.

Comparative Example: The rate decreased to 35%, indicating a decline in preference among companion animals.

Conclusion: The Example was more preferred by companion animals than the Comparative Example. As time passed, the quality of the Comparative Example deteriorated in terms of fat spoilage inhibition, fishy odor reduction, protein denaturation inhibition, and texture maintenance, whereas the quality of the Example was maintained, leading to a higher preference for the Example.

### (5) Conclusion

The Example showed excellent effects in all aspects, including inhibition of fat spoilage, reduction of fishy odor, inhibition of protein denaturation, maintenance of texture, and preference. In contrast, the Comparative Example showed clear quality degradation during the storage period and negative results in companion animal preference. Through the experiments, it was confirmed that the Example exhibited superior performance in inhibiting fat spoilage, reducing fishy odor, inhibiting protein denaturation, maintaining texture, and preference compared to the Comparative Example. This clearly proves the effectiveness of the production method and the category-specific soaking solution compositions of the present invention. These experimental results clearly demonstrate that the soaking and drying method of the present invention provides superior technical effects in the quality and preference of seafood-based treats.

It will be apparent to those skilled in the art that the present invention may be embodied in other specific forms without departing from the technical spirit and essential features of the invention. Therefore, the above-described embodiments should be considered in all respects as illustrative and not restrictive. The scope of the present invention should be determined by the reasonable interpretation of the appended claims and all changes that fall within the equivalent scope of the present invention.

What is claimed is:

1. A method for producing a seafood-based treat for companion animals by desalting and drying seafood, the method comprising:
based on the seafood corresponding to one of a plurality of predetermined seafood categories, wherein each of the plurality of predetermined seafood categories corresponds to a respective one of a plurality of predetermined soaking solutions, soaking the seafood using the soaking solution corresponding to the seafood category of the seafood; and
drying the soaked seafood,
wherein the plurality of seafood categories comprise:
(a1) fish having a fat content greater than a threshold fat content;
(b1) fish having a trimethylamine (TMA) content greater than a threshold TMA content, wherein the TMA is a component causing a fishy odor;
(c1) fish having a protein content greater than a threshold protein content; and
(d1) shellfish and crustaceans,
wherein the plurality of soaking solutions comprise:
(a2) a composition of 2 wt % of rosemary extract, 1 wt % of grapefruit seed extract, 1 wt % of green tea extract, and 96 wt % of purified water;
(b2) a composition of 1.5 wt % of green tea extract, 1 wt % of lemon extract, 1 wt % of *Ligularia fischeri(gomchwi) extract, 0.5 wt % of ginger extract, and 96 wt % of purified water;
(c2) a composition of 1 wt % of licorice extract, 1 wt % of jujube extract, 0.5 wt % of cinnamon extract, 0.2 wt % of citric acid, and 97.3 wt % of purified water; and
(d2) a composition of 1 wt % of green tea extract, 1 wt % of lemon balm extract, 1 wt % of licorice extract, and 97 wt % of purified water, and
wherein the category (a1) corresponds to the soaking solution (a2), the category (b1) corresponds to the soaking solution (b2), the category (c1) corresponds to the soaking solution (c2), and the category (d1) corresponds to the soaking solution (d2).

2. The method of claim 1,
wherein the category (a1) includes fish in which spoilage may proceed rapidly due to a fat content greater than the threshold fat content, and comprises mackerel, salmon, herring, yellowtail, Spanish mackerel, tuna, yellow croaker, and Atka mackerel,
wherein the category (b1) includes fish which may have low consumer preference due to a fishy odor caused by TMA content greater than the threshold TMA content, and comprises saury, sardine, horse mackerel, anchovy, hairtail, jack mackerel, *sambari (a type of grouper), and skate,
wherein the category (c1) includes fish in which textural changes may occur due to protein denaturation from a protein content greater than the threshold protein content, and comprises cod, pollock, flounder, sea bream, rockfish, tilefish, capelin, freshwater eel, and icefish, and
wherein the category (d1) includes seafood with delicate tissue that may be susceptible to quality degradation during preservation, and comprises squid, shrimp, crab, abalone, scallop, pen shell, and blue crab.

3. The method of claim 1,
wherein, in the soaking solution (a2), the rosemary extract, the grapefruit seed extract, and the green tea extract inhibit oxidation of fat in the seafood based on their antioxidant components,
wherein, in the soaking solution (b2), the green tea extract and the lemon extract reduce the fishy odor of the seafood, and the Ligularia fischeri(gomchwi) extract and the ginger extract improve the flavor of the seafood,
wherein, in the soaking solution (c2), the licorice extract and the jujube extract provide an antioxidant effect, the cinnamon extract provides an antimicrobial effect, and the citric acid preserves the texture of the tissue by inhibiting protein denaturation in the seafood through pH adjustment, and
wherein, in the soaking solution (d2), catechins in the green tea extract improve the preservability of the seafood by inhibiting microbial growth, and the lemon balm extract and the licorice extract improve the elasticity of the tissue of the seafood through antimicrobial and antioxidant actions.

4. The method of claim 1,
wherein the soaking of the seafood is performed using the soaking solution in an amount of at least five times the weight of the seafood, and
wherein the soaking is performed until a rate of change per hour in a salt concentration of the soaking solution is within a predetermined range.

5. The method of claim 1,
wherein the drying of the seafood comprises at least one of vacuum drying, hot-air drying, and freeze-drying,
wherein the vacuum drying is performed by drying the seafood at a temperature of 50° C. or less and a vacuum pressure of −0.8 bar or more for 2 to 6 hours,
wherein the hot-air drying is performed by drying the seafood using hot air at a temperature of 60° C. for 3 to 8 hours, and
wherein the freeze-drying is performed by freezing the seafood at −40° C. or less and then drying at a vacuum pressure of 0.1 mbar or less for 12 to 24 hours.

6. The method of claim 1, further comprising, before the soaking of the seafood:
removing skin, entrails, bones, and fatty parts from the seafood to form a fillet; or
in a case where the seafood is a shellfish, removing a shell of the seafood.

7. The method of claim 1,
wherein the threshold fat content is 8 wt % to 12 wt % inclusive, based on a dry weight of the seafood,
wherein the threshold TMA content is 3 parts per million (ppm) to 7 ppm inclusive, and
wherein the threshold protein content is 15 wt % to 18 wt % inclusive, based on the dry weight of the seafood.

8. The method of claim 1, further comprising, after the drying of the seafood:
sealing the dried seafood in a retort pouch comprised of a heat-resistant film; or
slicing the dried seafood into a predetermined size and then sealing in a retort pouch comprising a heat-resistant film.

9. A seafood-based treat for companion animals, produced by the method of claim 1.
